(19) United States
(12) Patent Application Publication
(10) Pub. No.: US 2025/0080398 A1
(43) Pub. Date: Mar. 6, 2025

(54) COMPUTING RESOURCE GRAPH EXPLORATION

(71) Applicant: Dazz, Inc., Palo Alto, CA (US)

(72) Inventors: Eshel YARON, Amsterdam (NL); Barak BERCOVITZ, Even-Yehuda (IL); Dvir HAZOUT, Hod Hasharon (IL)

(73) Assignee: Dazz, Inc., Palo Alto, CA (US)

(21) Appl. No.: 18/763,169

(22) Filed: Jul. 3, 2024

Related U.S. Application Data
(60) Provisional application No. 63/579,560, filed on Aug. 30, 2023.

(51) Int. Cl. H04L 41/0631; H04L 9/40

(52) U.S. Cl. CPC H04L 41/0631; H04L 63/1425

(57) ABSTRACT

A system and method for remediating alerts using graph exploration. A method includes creating a graph including a plurality of nodes and a plurality of edges, wherein the plurality of nodes includes a plurality of computing resource nodes representing respective computing resources among a computing infrastructure and a plurality of user nodes representing respective entities which make changes to the computing infrastructure; querying the graph based on a computing resource indicated in an alert; identifying a root cause of the alert based on results of the querying of the graph; and performing at least one mitigation action based on the identified root cause.

### CROSS-REFERENCE TO RELATED APPLICATIONS

This application claims the benefit of U.S. Provisional Patent Application No. 63/579,560 filed on Aug. 30, 2023, the contents of which are hereby incorporated by reference.

### TECHNICAL FIELD

The present disclosure relates generally to cybersecurity for computing infrastructures, and more specifically to performing root cause analysis via graph exploration.

### BACKGROUND

Many companies provide tools for monitoring behavior in computing infrastructures which may be used to help identify and mitigate potential cyber threats. These alerts often provide some general information about where abnormal or otherwise potentially malicious behavior has been identified within the infrastructure. However, as computing infrastructures grow, so too does the amount of alerts being generated for any given computing infrastructure. Thus, identifying root causes and prioritizing alerts has become critical for infrastructure cybersecurity.

Even if a computing resource acting as a component of the infrastructure can be traced back as the source of an issue, that information alone may still be insufficient to promptly respond to an alert. In particular, the person who created the resource originally may be documented as the owner, but others may modify the resource after it is initially created. As a result, it is challenging to identify the person who is really responsible for any given alert being triggered. Solutions which allow for more accurately identifying potential root causes of alerts with respect to changes in the infrastructure would therefore be desirable.

Additionally, as noted above, prioritization of alerts has become critical due to the time sensitive nature of cybersecurity threats. The large amount of alerts being generated in computing infrastructures has resulted in an exponentially growing number of alerts which may relate to any given computing resource or part of the computing infrastructure. Consequently, new techniques for prioritizing alerts are highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for remediating alerts using graph exploration. The method comprises: creating a graph including a plurality of nodes and a plurality of edges, wherein the plurality of nodes includes a plurality of computing resource nodes representing respective computing resources among a computing infrastructure and a plurality of user nodes representing respective entities which make changes to the computing infrastructure; querying the graph based on a computing resource indicated in an alert; identifying a root cause of the alert based on results of the querying of the graph; and performing at least one mitigation action based on the identified root cause.

Certain embodiments disclosed herein also include a non-transitory computer readable medium having stored thereon causing a processing circuitry to execute a process, the process comprising: creating a graph including a plurality of nodes and a plurality of edges, wherein the plurality of nodes includes a plurality of computing resource nodes representing respective computing resources among a computing infrastructure and a plurality of user nodes representing respective entities which make changes to the computing infrastructure; querying the graph based on a computing resource indicated in an alert; identifying a root cause of the alert based on results of the querying of the graph; and performing at least one mitigation action based on the identified root cause.

Certain embodiments disclosed herein also include a system for remediating alerts using graph exploration. The system comprises: a processing circuitry; and a memory, the memory containing instructions that, when executed by the processing circuitry, configure the system to: creating a graph including a plurality of nodes and a plurality of edges, wherein the plurality of nodes includes a plurality of computing resource nodes representing respective computing resources among a computing infrastructure and a plurality of user nodes representing respective entities which make changes to the computing infrastructure; querying the graph based on a computing resource indicated in an alert; identifying a root cause of the alert based on results of the querying of the graph; and performing at least one mitigation action based on the identified root cause.

Certain embodiments disclosed herein include the method, non-transitory computer readable medium, or system noted above, wherein the plurality of nodes further includes a plurality of action nodes, wherein each action node represents a respective action initiated by one of the entities which makes changes to the computing infrastructure.

Certain embodiments disclosed herein include the method, non-transitory computer readable medium, or system noted above, wherein each action node is connected to a user node representing a user who initiated the action represented by the action node, wherein each action node is further connected to a computing resource node representing a computing resource that was created or modified via the action.

Certain embodiments disclosed herein include the method, non-transitory computer readable medium, or system noted above, wherein the graph further includes a plurality of time values corresponding to respective edges of the plurality of edges, wherein the graph is queried based further on a time of the alert.

Certain embodiments disclosed herein include the method, non-transitory computer readable medium, or system noted above, wherein a result of querying the graph includes a subset of the plurality of nodes and the plurality of edges, wherein the subset corresponds to a state of the computing infrastructure as represented in the graph at the time of the alert.

Certain embodiments disclosed herein include the method, non-transitory computer readable medium, or system noted above, wherein the at least one anomalous change is determined based on one of the entities which made the at least one anomalous change.

Certain embodiments disclosed herein include the method, non-transitory computer readable medium, or system noted above, further including or being configured to perform the following steps: detecting at least one anomaly based on a result of querying the graph, wherein the at least one anomaly is at least one anomalous change to the computing infrastructure.

Certain embodiments disclosed herein include the method, non-transitory computer readable medium, or system noted above, further including or being configured to perform the following steps: aggregating a plurality of nodes having at least one common root cause among the plurality of nodes; and updating the graph based on the aggregated plurality of nodes having the at least one common root cause, wherein the updated graph is queried.

Certain embodiments disclosed herein include the method, non-transitory computer readable medium, or system noted above, further including or being configured to perform the following steps: generating an aggregated node based on the plurality of nodes having the at least one common root cause, wherein updating the graph further comprises replacing the plurality of nodes having the at least one common root cause with the aggregated node.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for remediation using cloud resource graph exploration according to an embodiment.

FIG. 3 is a flowchart illustrating a method for node aggregation according to an embodiment.

FIG. 4 is a flowchart illustrating a method for timeline exploration according to an embodiment.

FIG. 5 is a schematic diagram of a remediator according to an embodiment.

FIG. 6 is a schematic diagram of an explorer according to an embodiment.

FIGS. 7A-D are example illustrations of a sequence of graph displays utilized to illustrate various disclosed embodiments.

### DETAILED DESCRIPTION

The various disclosed embodiments include methods and systems for graphing computing resources and for performing root cause analysis using graph exploration techniques. The disclosed embodiments include various techniques for graphing a computing infrastructure which utilizes connections between users and changes made to computing resources among the computing infrastructure in order to provide more granular data related to potential root causes. Various disclosed embodiments utilize the increased granular data related to root causes in order to more efficiently mitigate potential cybersecurity threats.

To this end, in accordance with various disclosed embodiments, a graph is created including nodes and edges. The nodes of the graph at least include computing resource nodes representing computing resources deployed in a computing infrastructure as well as user nodes representing entities which create or modify computing resources deployed in the computing infrastructure. The edges represent connections between nodes among the graph such as, but not limited to, edges representing changes made by users to computing resources. The graph may further include other kinds of nodes such as, but not limited to, action nodes representing commands or other actions initiated by users which may result in creation or modification of computing resources, as well as edges between such action nodes and the computing resource nodes corresponding to the computing resources created or modified by the respective actions.

Various disclosed embodiments further graph the computing infrastructure temporally, that is, by graphing states of the infrastructure at different points in time. To this end, in such embodiments, the graph may further include temporal variation data such as, but not limited to, times or time periods in which certain entities represented by nodes in the graph were created or generated, initiated, changed, or otherwise triggered a kind of activity that is represented by nodes and edges in the graph. Such temporal variation data may be determined based on, for example, timestamps of certain events within the computing infrastructure, such as timestamps indicated in audit logs for the computing infrastructure.

The disclosed embodiments also include techniques for aggregating alerts with respect to root causes. To this end, in such embodiments, the graph further includes alert nodes representing respective alerts. The alert nodes may be connected via edges to respective computing resource nodes of computing resources which the corresponding alerts indicate. This reduces the number of potential nodes in the graph, which both reduces the amount of data needed to be stored in the graph as well as the amount of nodes needed to be rendered when visually displaying the graph. Moreover, reducing the number of nodes visually displayed as part of the graph improves the visualization of the connections represented in the graph, which in turn aids in root cause analysis.

In addition to aiding in automated remediation as described herein, the disclosed techniques allow for visualizing a root cause analysis via the graph in which the graph serves as an interactable proof of a given root cause and, more specifically, a root cause defined with respect to changes made by a given user.

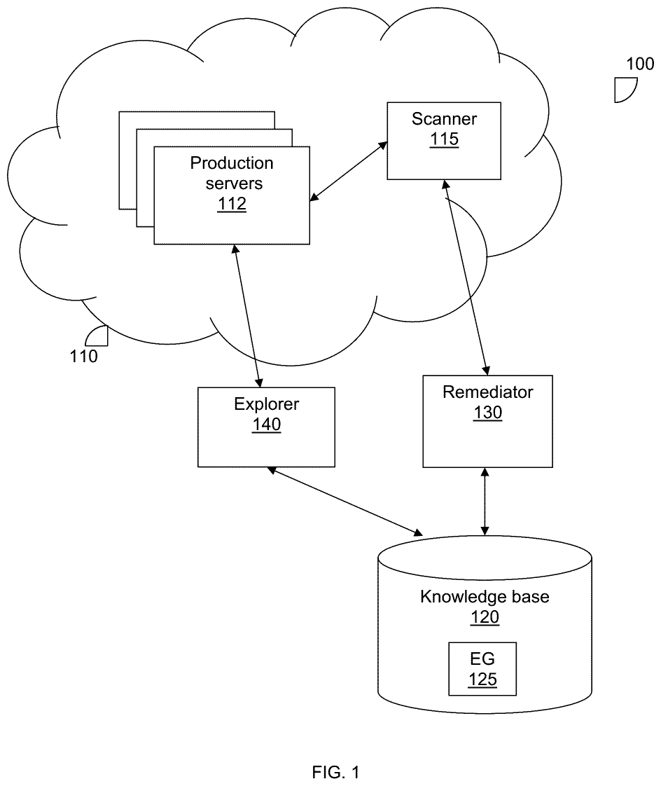

FIG. 1 shows an example network diagram 100 utilized to describe the various disclosed embodiments. The example network diagram 100 illustrates a computing infrastructure 110, a knowledge base 120, a remediator 130, and an explorer 140. The computing infrastructure 110 may be realized via one or more networks such as, but not limited to, a wireless, cellular or wired network, a local area network (LAN), a wide area network (WAN), a metro area network (MAN), the Internet, the worldwide web (WWW), similar networks, and any combination thereof. The computing infrastructure 110 may be or may include, but is not limited to, a cloud computing platform.

The computing infrastructure 110 includes production servers 112 and one or more scanners 115. The production servers 112 may be configured to deploy and host applications in the computing infrastructure 110 by one or more software developer devices (not shown). The production servers 112 may be configured to utilize computing resources (not depicted) in order to perform tasks via one or more processes or groups of processes (not depicted). Such computing resources may be internal resources acting as logical components of the production servers 112 realized via portions of software.

The scanners 115 are configured to scan the computing infrastructure 110, binary artifacts, code, combinations thereof, and the like, and are configured to generate cybersecurity event data such as alerts related to network activity, potential sources of cybersecurity events, intermediate representations of such potential sources, resulting artifacts of the software development process, combinations thereof, and the like. To this end, the scanners 115 may include, but are not limited to, scanners (e.g., cloud scanners), application security scanners, linting tools, combinations thereof, and any other security validation tools that may be configured to monitor network activities or potential sources of cybersecurity events.

Any scanners among the scanners 115 are configured to monitor for network activities and are configured to generate sources of cybersecurity event data. To this end, such scanners may be configured to monitor network activity and to generate logs of such network activity, or may be configured to monitor suspicious behavior and to generate alerts when such suspicious behavior is identified. The alerts may include information about the events, entities, or both, that triggered the alerts. In accordance with various disclosed embodiments, the scanners 115 may be further configured to generate log data indicating changes in the computing infrastructure such as, but not limited to, changes in computing resources realized via the production servers 112.

The cybersecurity event data included in the cybersecurity event data sources may be provided, for example, in the form of textual data. Such textual data may be analyzed using natural language processing and a semantic concepts dictionary in order to identify entity-identifying values representing specific entities in software development infrastructure which are related to the cybersecurity events, semantic concepts indicating types or other information about entities related to the cybersecurity events, both, and the like.

The knowledge base 120 stores data used for root cause remediation in accordance with various disclosed embodiments. Such data includes, but is not limited to, an entity graph (EG) 125. The entity graph 125 includes nodes and edges connecting between nodes, where at least some of the nodes include at least computing resource nodes representing computing resources deployed in the computing infrastructure 110 as well as user nodes representing entities (not shown) which create or modify computing resources deployed in the computing infrastructure 110. In accordance with certain disclosed embodiments, the nodes of the entity graph 125 may further include nodes representing activities which create or change computing resources, nodes representing alerts, both, and the like.

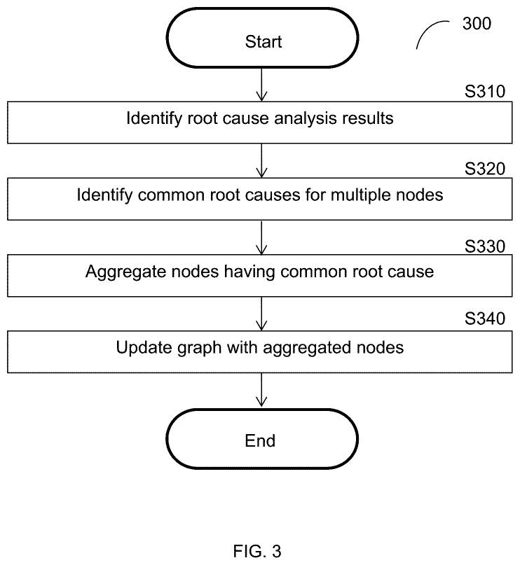

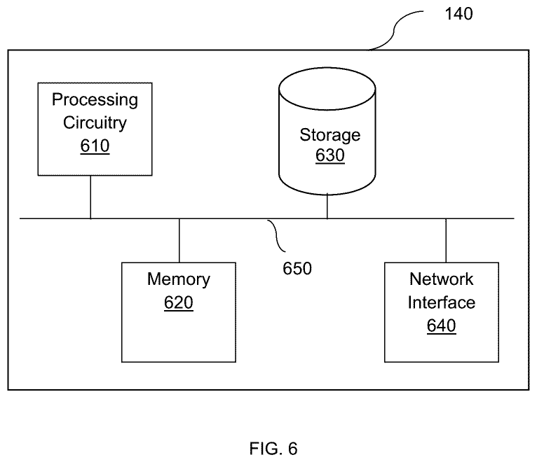

To this end, in an embodiment, the explorer 140 is configured to populate the knowledge base 120 with data to be used by the remediator 130 including, but not limited to, the entity graph 125. The explorer 140 may include, but is not limited to, a processing circuitry and a memory (e.g., as depicted in FIG. 6), where the memory contains instructions that configure the explorer 140 to populate the knowledge base 120 as described herein when the instructions are executed by the processing circuitry. An example method for creating a knowledge base which may be performed by the explorer 140 is described further below with respect to FIG. 3.

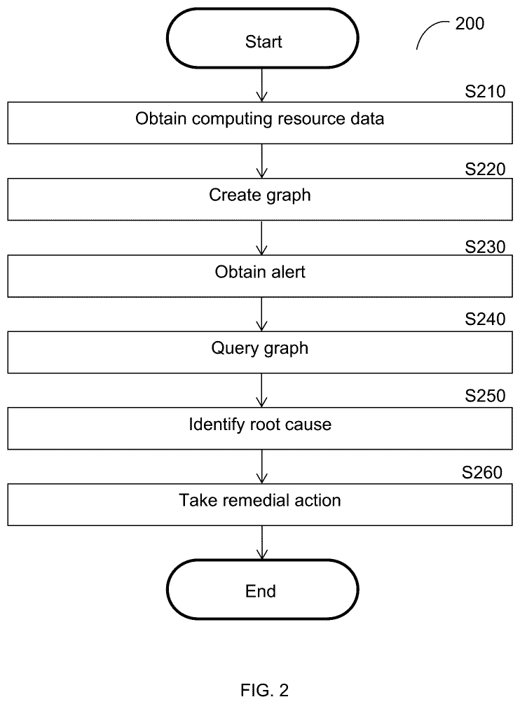

The remediator 130, in turn, is configured to identify root causes of alerts based on entities indicated in those alerts. To this end, the remediator 130 may be configured to query the heat map 125 using an address of such an entity in order to identify entities related to changes which may have triggered the alert and may therefore be or relate to potential root cause of the alert. An example process for remediating alerts is described below with respect to FIG. 2.

It should be noted that the example network diagram depicted in FIG. 1 illustrates a particular arrangement of communicating components merely for simplicity purposes, but that the disclosed embodiments are equally applicable to different computing configurations. As a non-limiting example, any of the knowledge base 120, the remediator 130, and the explorer 140 may be deployed in the computing infrastructure 110 without departing from the scope of the disclosure. Additionally, the monitored software may be deployed in an infrastructure other than a cloud computing infrastructure such as, but not limited to, an on-premises infrastructure.

FIG. 2 is a flowchart 200 illustrating a method for remediation using cloud resource graph exploration according to an embodiment. In an embodiment, the method is performed by the remediator 130, FIG. 1.

At S210, computing resource data is obtained. The computing resource data indicates at least computing resources of a computing infrastructure (e.g., computing resources realized via the production servers 112 of the computing infrastructure 110, FIG. 1). The computing resource data may be or may include, but is not limited to, comma separated values (CSV) data.

Such data may be generated by scanners or other cybersecurity tools configured to identify and collect data related to computing resources deployed in and with respect to computing infrastructures. Moreover, the computing resource data may indicate relations between the computing resources (e.g., data related to communications between computing resources which indicate potential connections between the computing resources in data flows or otherwise with respect to activities performed in the computing environments).

In accordance with various disclosed embodiments, the computing resource data may be or may include log data such as, but not limited to, audit logs, indicating changes made to the computing infrastructure. Such changes may include, but are not limited to, creation of computing resources, modifications of computing resources, connecting computing resources, combinations thereof, portions thereof, and the like.

The computing resources may be, but are not limited to, devices, programs, applications, virtual machines, software containers, or other computing resources which are utilized to perform activities with respect to the computing environments. The computing resources may be identified within the computing resource data with respect to identifiers such as, but not limited to, Internet Protocol (IP) addresses, Domain Name System (DNS) addresses, both, and the like.

At S220, a graph is created based on the computing resource data. The graph may be created, for example, by the remediator 130 performing the method of FIG. 2 or by another system such as the explorer 140, FIG. 1.

In an embodiment, the graph includes multiple nodes and multiple edges, with the nodes at least including computing resource nodes representing computing resources deployed in a computing infrastructure as well as user nodes representing entities which create or modify computing resources deployed in the computing infrastructure. The edges represent connections between nodes among the graph such as, but not limited to, edges representing changes made by users to computing resources. The graph may further include other kinds of nodes such as, but not limited to, action nodes representing commands or other actions initiated by users which may result in creation or modification of computing resources, as well as edges between such action nodes and the computing resource nodes corresponding to the computing resources created or modified by the respective actions. The action nodes may represent actions such as, but not limited to, altering at least a portion of code (e.g., via a commit), creating a computing resource (e.g., an instance of a software container), creating a component used by a computing resource (e.g., a container image of a software container), and the like.

In a further embodiment, the graph is created so as to aggregate at least some of the nodes, edges, or both. More specifically, in some such embodiments, alert nodes may be aggregated based on common root causes. An example process for such alert node aggregation is described further below with respect to FIG. 3.

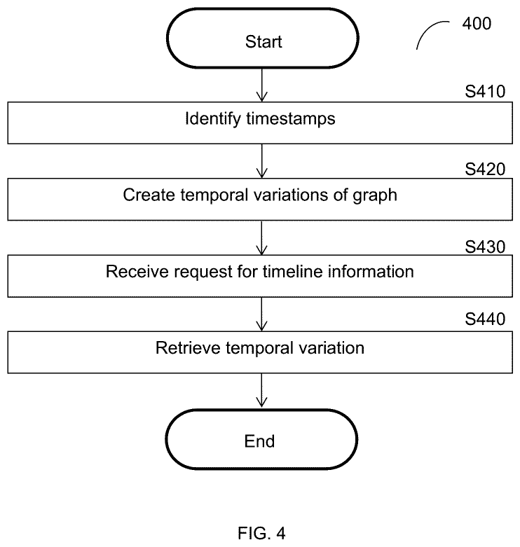

In another embodiment, the graph may further include temporal variation data indicating times (e.g., specific times or time periods) at which changes represented in the graph were made. The changes in the graphs may include, but are not limited to, creation or modification of computing resources (reflected in computing resource nodes or action nodes being added to the graph), generation of alerts (reflected in new alert nodes being added to the graph), both, and the like. Such times may be determined based on data such as, but not limited to, timestamps included in log data among the computing resource data. An example process for creating temporal variations in a graph and for utilizing such temporal variations is described further below with respect to FIG. 4.

At S230, an alert is obtained. The alert may be received, for example, from a scanner deployed in a computing infrastructure (e.g., one of the scanners 115, FIG. 1). The alert indicates one or more computing resources which are otherwise suspected of having an issue which may be indicative of a potential cybersecurity threat or otherwise triggered the alert. For example, the alert may indicate a network address or other identifier of each such computing resource.

At S240, the graph is queried based on a computing resource indicated in the alert. Querying the graph at least results in data indicating one or more users which are connected to the computing resources indicated in the alert via changes made to create or modify those computing resources.

As noted above, in some embodiments, the graph may include temporal variation data. To this end, in such embodiments, the query may further be based on a time of the alert (e.g., a time indicated by a timestamp of the alert) such that the results of the query may include a temporal variation of the graph or otherwise include data for a time period including the time of the alert. This allows for further improving the accuracy of root cause identification and by filtering out nodes which may be related to potential root causes, e.g., nodes corresponding to entities represented in the graph that were added based on events preceding the alert instead of events that followed the alert, i.e., since changes to the infrastructure made after a given alert was triggered can be eliminated as potential root causes. This reduces consumption of computing resources needed to retrieve, process, and render portions of the graph reflecting such post-alert activities.

In this regard, it is noted that alerts and log data typically have timestamps reflecting when certain events happened with respect to the computing infrastructure. More specifically, alerts typically include timestamps indicating a time at which the alert was generated, which in turn is indicative of when a problem was identified. Log data often includes timestamps indicating when certain changes were made to the infrastructure, for example, when a resource was created or when a commit was made in order to change code of a resource.

Accordingly, such temporal variation data effectively allows for “time traveling” through the development of the computing infrastructure, which as noted above can be utilized in order to filter out entities which are potentially related to root causes without needing to analyze their connections to other entities represented in the graph. Moreover, when multiple changes are made to computing resources in the infrastructure, such temporal variations may further help with pinpointing which change actually triggered a given alert in order to more efficiently identify the root cause and take remedial action.

At S250, a root cause is identified based on the results of querying the graph. The root cause may be identified as the user which caused a change to a computing resource that triggered the alert, a change made by such a user, a combination thereof, and the like.

In some embodiments, S250 further includes detecting one or more anomalies based on the results of querying the graph. In a further embodiment, S250 includes applying one or more anomaly detection rules defined with respect to potential connections in the graph. To this end, the anomaly detection rules may be defined with respect to an anomalous change to the computing infrastructure, for example, as represented by an anomalous creation or change of a computing resource.

As a non-limiting example for anomaly detection using the graph, one such rule may define anomalous changes with respect to a specific entity or type of entity that made a modification. As a further non-limiting example, an anomaly detection rule may be defined such that a modification to a computing resource made by a human user is anomalous when the computing resource was created by an infrastructure as code (IaC) function. Such a rule may be defined, for example, because in some implementations, computing resources created by IaV should only be managed (including being modified) by laC and not by users of the computing infrastructure.

At S260, remedial action is taken with respect to the identified root cause. The remedial action may include, but is not limited to, generating and sending a notification, performing mitigation actions such as changing configurations of software components, changing code of software components, combinations thereof, and the like. As a non-limiting example, a configuration of a root cause entity that is a computing resource may be changed from “allow” to “deny” with respect to a particular capability of the computing resource, thereby mitigating the cause of the cybersecurity event. In some embodiments, S260 includes following a list of steps to fix underlying issues with the root cause. When the remediation actions include sending notifications, the notifications may be sent to one or more users identified as part of the root cause such as one or more users who made changes to computing resources which triggered the alert.

In a further embodiment, the remedial action may include causing a display of a sequential illustration of a series of events leading to triggering an alert which may be useful for helping a user identify potential portions of the computing infrastructure requiring correction. Such a sequence may be generated using the temporal variation data in order to show a series of changes to the graph leading up to the triggering of the alert. This, in turn, may be displayed to a user, thereby allowing the user to more efficiently identify potential root causes or other potential sources of problematic changes, which in turn allows that user to more efficiently implement remedial actions in order to address potential vulnerabilities which related to the triggering of the alert.

Moreover, in some implementations, the sequential illustration may only include nodes and edges of the graph which are related to the triggering of the alert, e.g., nodes connected either directly or indirectly (i.e., through other nodes) to the alert and any edges in between. Alternatively or in combination, the sequence may only illustrate changes to the computing infrastructure in the time period immediately preceding an alert (e.g., within a predetermined time period prior to the alert being generated). The sequence may be viewed out of order in at least some implementations, and to this end the graph may be displayed with an interactable user interface element allowing for selection of a time or time period for display. Any or all of such implementations may allow for further improving efficiency of user analysis and remedial actions by automatically filtering certain portions of the graph, of the events depicted via the graph, or both, which are unlikely to be relevant for remediation and therefore reducing the amount of graph needed to be analyzed by the user. Further, only illustrating changes immediately preceding the alert reduces the number of illustrations or portions of the graph needing to be rendered and displayed.

As a non-limiting example of a sequence of graph displays illustrating events leading up to an alert, a series of displays showing the graph at different points in time may be shown, with a first display depicting only a connection between a computing resource and a user who created the computing resource, a second display also depicting a commit made to change the code of the computing resource by another user in addition to the information shown in the first display, and a third display also depicting an alert indicating the computing resource in addition to the information shown in the first and second displays. Such a sequential display illustrates the process from creation of the computing resource through a modification of the computing resource that triggered an alert, thereby demonstrating a likely root cause (i.e., the modification of the computing resource).

FIG. 3 is a flowchart 300 illustrating a method for node aggregation according to an embodiment. In an embodiment, the method is performed by the explorer 140, FIG. 1.

At S310, root cause analysis results are identified. The root cause analysis results may be results from previous queries of a graph as described herein, and may indicate which actions, users, or both, are related to the root cause of an alert. To this end, the root cause analysis results may include action nodes, user nodes, or both, connected to an alert node representing the alert as determined based on results of querying the graph.

Moreover, in some embodiments, the root cause analysis results are identified further with respect to the temporal variations of the graph. That is, the root cause analysis results may include nodes connected to the alert node such that the included nodes are nodes which were present in the graph when the alert node was added to the graph, i.e., the nodes only include nodes added to the graph in the time leading up to the alert being triggered instead of also including nodes added to the graph after the alert is triggered.

At S320, at least one common root cause is identified for each of one or more sets of multiple nodes. More specifically, the common root cause may be a node that is connected, either directly or indirectly, to multiple alert nodes. In some implementations, the common root causes may include user nodes, action nodes (e.g., action nodes representing commit actions that change code of computing resources), both, and the like.

At S330, nodes having common root causes as identified at S320 are aggregated. In an embodiment, the aggregation includes generating a single node to replace multiple nodes having a root cause or set of root causes in common. In a further embodiment, alert nodes are aggregated. In some embodiments, aggregation is performed among nodes when the number of nodes having the same root cause or root causes in common is above a threshold (e.g., a predetermined threshold number, or a predetermined threshold percentage of the total number of alert nodes in the graph). The aggregated nodes may further be nodes having the same edges, i.e., connections to the same other node or nodes.

In some embodiments, the aggregation may be context-specific. To this end, in some embodiments, root causes may be contextually defined based on factors such as, but not limited to, type of tool the root cause relates to (e.g., Terraform), type of platform the root cause relates to (e.g., Docker), type of change (e.g., manual change or change by laC), combinations thereof, and the like. More specifically, root causes may be defined with respect to an action changing the computing infrastructure, and alerts related to the same root cause action may be aggregated.

At S340, a graph is updated with the aggregated nodes. In an embodiment, S340 includes replacing the multiple nodes being aggregated with the corresponding aggregated node, thereby reducing the number of nodes in the graph. In a further embodiment, S340 further includes connecting, via one or more edges, the aggregated node to other nodes in the graph (i.e., the other nodes to which all of the nodes being aggregated are connected).

FIG. 4 is a flowchart 400 illustrating a method for timeline exploration according to an embodiment. In an embodiment, the method is performed by the explorer 140, FIG. 1.

At S410, timestamps are identified with respect to nodes in a graph. The timestamps may be identified in log data or other data indicating computing resources in a computing infrastructure (e.g., computing resources identified by network address or other identifier). As noted above, the timestamps may indicate, for example, times at which alerts were generated, times at which computing resources were created or modified, both, and the like.

At S420, temporal variations of a graph are created. In an embodiment, each temporal variation includes at least a subset of the nodes and edges of the graph representing a state of the computing infrastructure at a specific point in time or time period. Creating the temporal variations may include, but is not limited to, storing time information in the graph (e.g., assigning a time value to edges). As a non-limiting example, an edge between an alert node and a computing resource node may be assigned a time value indicating a time at which the alert represented by the alert node was triggered. As another non-limiting example, an edge between a computing resource node and an action node representing a commit command made with respect to a computing resource represented by the computing resource node may be assigned a time value representing a time at which the commit command was executed.

In some implementations, time periods may be defined with respect to audits. That is, the time period between audits may be considered as a time period of a stage of the computing infrastructure. To this end, in some embodiments, the graph may further include time values corresponding to times at which audit data was ingested, for example, timestamps of audit logs.

At S430, a request for timeline information is received. The request may indicate a specific time or time period for which timeline information of the graph is desired.

At S440, a temporal variation is retrieved based on the time indicated in the request. In an embodiment, S440 includes retrieving nodes and edges of the graph from the specific time or time period indicated in the request.

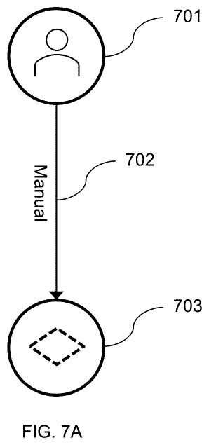

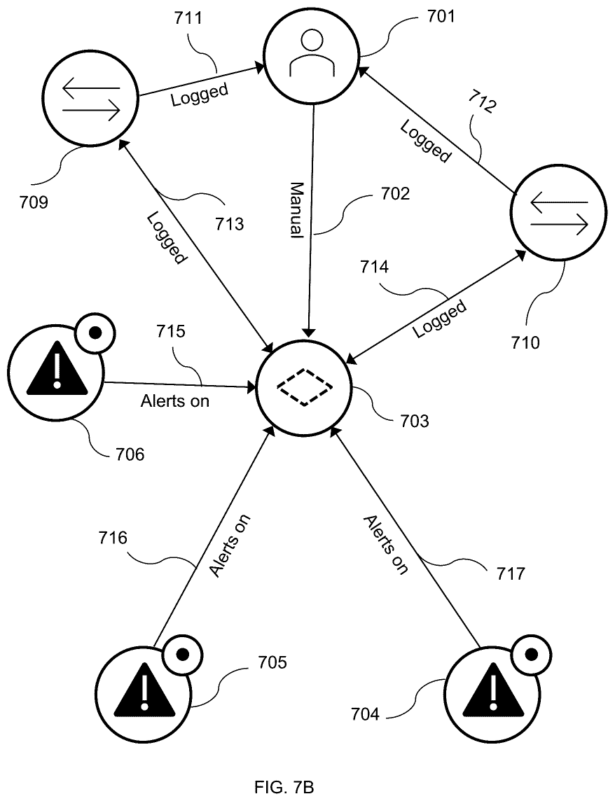

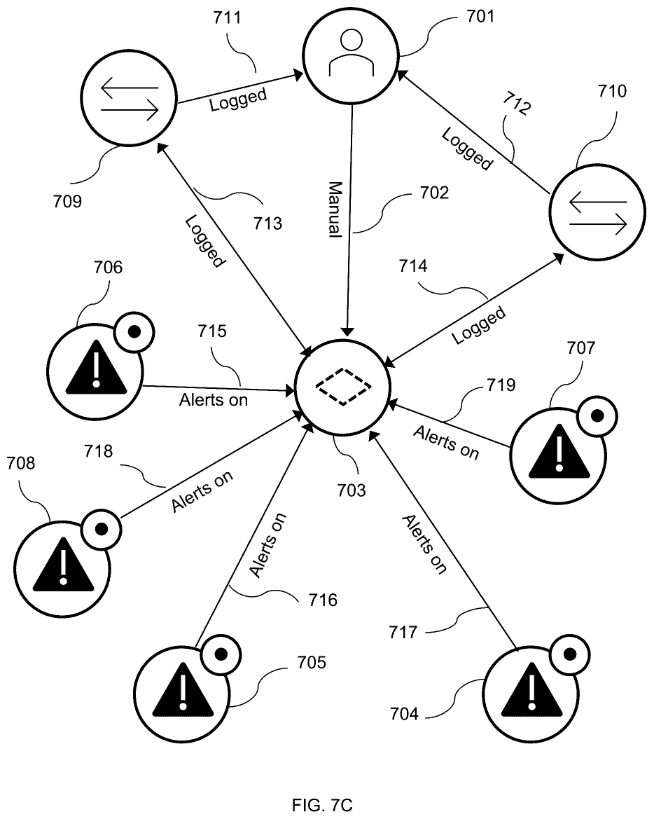

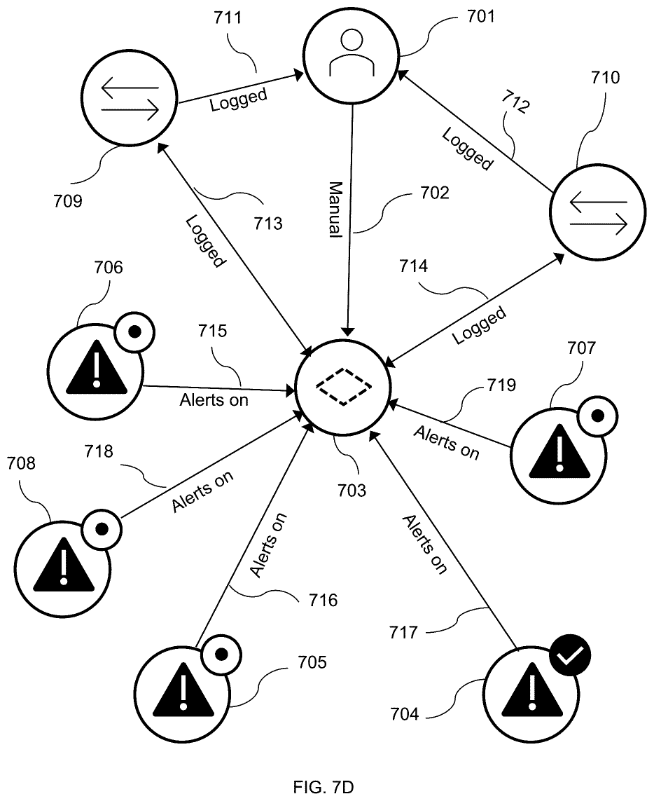

FIGS. 7A-D show respective illustrations 700A through 700D, respectively, illustrating different temporal variations of a graph representing states of a computing infrastructure over time. The illustration 700A demonstrates a user represented by a user node 701 manually creating a cloud object bucket represented by a computing resource node 703, where the creation of the cloud object bucket is represented by an edge 702. The illustration 700B demonstrates new nodes added after audit data is ingested. Specifically, three alert nodes 704, 705, and 706 representing as-of-yet unresolved alerts are added. The illustration 700C demonstrates the addition of two more alert nodes 707 and 708. The illustration 700D demonstrates that one of the alerts represented by the alert node 704 has resolved, which may be reflected in the graph by a visual distinction from alert nodes of unresolved alerts.

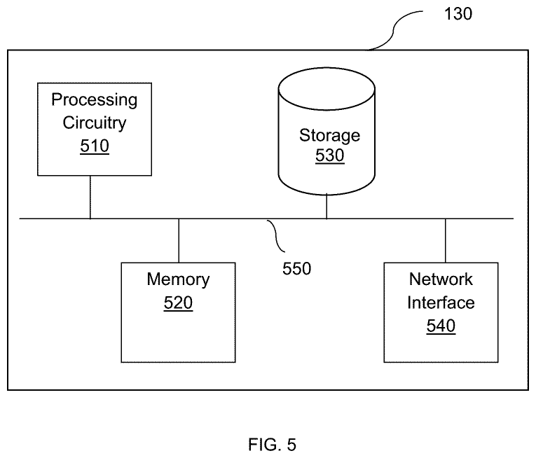

FIG. 5 is an example schematic diagram of a remediator 130 according to an embodiment. The remediator 130 includes a processing circuitry 510 coupled to a memory 520, a storage 530, and a network interface 540. In an embodiment, the components of the remediator 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the remediator 130 to communicate with, for example, the scanners 115, the knowledge base 120, and the like.

It should be understood that the embodiments described herein are not limited to the specific architecture illustrated in FIG. 5, and other architectures may be equally used without departing from the scope of the disclosed embodiments.

FIG. 6 is an example schematic diagram of an explorer 140 according to an embodiment. The explorer 140 includes a processing circuitry 610 coupled to a memory 620, a storage 630, and a network interface 640. In an embodiment, the components of the explorer 140 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the explorer 140 to communicate with, for example, the production servers 112, the knowledge base 120, and the like.

It should be understood that the embodiments described herein are not limited to the specific architecture illustrated in FIG. 6, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for remediating alerts using graph exploration, comprising:
creating a graph including a plurality of nodes and a plurality of edges, wherein the plurality of nodes includes a plurality of computing resource nodes representing respective computing resources among a computing infrastructure and a plurality of user nodes representing respective entities which make changes to the computing infrastructure;
querying the graph based on a computing resource indicated in an alert;
identifying a root cause of the alert based on results of the querying of the graph; and
performing at least one mitigation action based on the identified root cause.

2. The method of claim 1, wherein the plurality of nodes further includes a plurality of action nodes, wherein each action node represents a respective action initiated by one of the entities which makes changes to the computing infrastructure.

3. The method of claim 2, wherein each action node is connected to a user node representing a user who initiated the action represented by the action node, wherein each action node is further connected to a computing resource node representing a computing resource that was created or modified via the action.

4. The method of claim 1, wherein the graph further includes a plurality of time values corresponding to respective edges of the plurality of edges, wherein the graph is queried based further on a time of the alert.

5. The method of claim 4, wherein a result of querying the graph includes a subset of the plurality of nodes and the plurality of edges, wherein the subset corresponds to a state of the computing infrastructure as represented in the graph at the time of the alert.

6. The method of claim 1, wherein identifying the root cause of the alert further comprises:
detecting at least one anomaly based on a result of querying the graph, wherein the at least one anomaly is at least one anomalous change to the computing infrastructure.

7. The method of claim 6, wherein the at least one anomalous change is determined based on one of the entities which made the at least one anomalous change.

8. The method of claim 1, further comprising:
aggregating a plurality of nodes having at least one common root cause among the plurality of nodes; and
updating the graph based on the aggregated plurality of nodes having the at least one common root cause, wherein the updated graph is queried.

9. The method of claim 8, wherein aggregating the plurality of nodes having the at least one common root cause further comprises:
generating an aggregated node based on the plurality of nodes having the at least one common root cause, wherein updating the graph further comprises replacing the plurality of nodes having the at least one common root cause with the aggregated node.

10. A non-transitory computer readable medium having stored thereon instructions for causing a processing circuitry to execute a process, the process comprising:
creating a graph including a plurality of nodes and a plurality of edges, wherein the plurality of nodes includes a plurality of computing resource nodes representing respective computing resources among a computing infrastructure and a plurality of user nodes representing respective entities which make changes to the computing infrastructure;
querying the graph based on a computing resource indicated in an alert;
identifying a root cause of the alert based on results of the querying of the graph; and
performing at least one mitigation action based on the identified root cause.

11. A system for remediating alerts using graph exploration, comprising:
a processing circuitry; and
a memory, the memory containing instructions that, when executed by the processing circuitry, configure the system to:
create a graph including a plurality of nodes and a plurality of edges, wherein the plurality of nodes includes a plurality of computing resource nodes representing respective computing resources among a computing infrastructure and a plurality of user nodes representing respective entities which make changes to the computing infrastructure;
query the graph based on a computing resource indicated in an alert;
identify a root cause of the alert based on results of the querying of the graph; and
perform at least one mitigation action based on the identified root cause.

12. The system of claim 11, wherein the plurality of nodes further includes a plurality of action nodes, wherein each action node represents a respective action initiated by one of the entities which makes changes to the computing infrastructure.

13. The system of claim 12, wherein each action node is connected to a user node representing a user who initiated the action represented by the action node, wherein each action node is further connected to a computing resource node representing a computing resource that was created or modified via the action.

14. The system of claim 11, wherein the graph further includes a plurality of time values corresponding to respective edges of the plurality of edges, wherein the graph is queried based further on a time of the alert.

15. The system of claim 14, wherein a result of querying the graph includes a subset of the plurality of nodes and the plurality of edges, wherein the subset corresponds to a state of the computing infrastructure as represented in the graph at the time of the alert.

16. The system of claim 11, wherein the system is further configured to:
detect at least one anomaly based on a result of querying the graph, wherein the at least one anomaly is at least one anomalous change to the computing infrastructure.

17. The system of claim 16, wherein the at least one anomalous change is determined based on one of the entities which made the at least one anomalous change.

18. The system of claim 11, wherein the system is further configured to:
aggregate a plurality of nodes having at least one common root cause among the plurality of nodes; and
update the graph based on the aggregated plurality of nodes having the at least one common root cause, wherein the updated graph is queried.

19. The system of claim 18, wherein the system is further configured to:
generate an aggregated node based on the plurality of nodes having the at least one common root cause, wherein updating the graph further comprises replacing the plurality of nodes having the at least one common root cause with the aggregated node.
